(19) United States
(12) Patent Application Publication
(10) Pub. No.: US 2022/0301237 A1
(43) Pub. Date: Sep. 22, 2022

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Yuzuru SUZUKI, Kanagawa (JP)

(73) Assignee: FUJIFILM BUSINESS INNOVATION CORP., Tokyo (JP)

(21) Appl. No.: 17/377,598

(22) Filed: Jul. 16, 2021

(30) Foreign Application Priority Data
Mar. 22, 2021 (JP) 2021-046935

(51) Int. Cl. G06T 11/00; G06N 20/00; G06F 16/583; G06T 5/50

(52) U.S. Cl. CPC G06T 11/001; G06N 20/00; G06F 16/5838; G06F 16/5854; G06T 5/50

(57) ABSTRACT

An information processing apparatus includes a processor configured to: in a color assignment state where mutually different colors are each assigned to a corresponding one of types of images, input target images to artificial intelligence trained by machine learning and acquire post-conversion images each resulting from conversion of a corresponding one of the target images, the conversion being performed by the artificial intelligence trained to convert an input image to a pattern image of a solid color serving as the color assigned to the type of the input image or to a pattern image of multiple colors; and in the color assignment state, execute a determination process for determining a type of each target image on a basis of closeness between a color of the corresponding post-conversion image and each of the colors assigned to the types of images.

### CROSS-REFERENCE TO RELATED APPLICATIONS

This application is based on and claims priority under 35 USC 119 from Japanese Patent Application No. 2021-046935 filed Mar. 22, 2021.

### BACKGROUND

### (i) Technical Field

The present disclosure relates to an information processing apparatus and a non-transitory computer readable medium.

### (ii) Related Art

There are systems that recognize various objects such as text, a graphic, and a photo image included in a document image and that perform a process appropriate for the object recognition result, such as extracting individual objects or performing image processing appropriate for the object type.

To date, objects have been recognized on the basis of a document structure analysis, image feature extraction, or other methods.

For example, in the method disclosed in Japanese Unexamined Patent Application Publication No. 2001-76095, a text area and a picture area are recognized by analyzing the layout of an input document image, and an area where the recognized text and picture areas overlap each other is then detected. If an overlapping area is detected, data regarding the document image is then stored after changing the method for storing the document image data.

In recent years, a neural network has been used actively in the image processing.

For example, Japanese Unexamined Patent Application Publication No. 2020-46736 discloses a method using a generative adversarial network (GAN) for identifying an image code area in the input image. In the method, an input image including an image code is input to the generator of the GAN. The generator is a neural network that generates an image representing an image-code inference area in the input image. The discriminator of the GAN receives a correct image representing a correct image-code area in the input image or the generated image generated by the generator. The discriminator discriminates whether the input image is the correct image or the generated image. A large number of input images and correct images are input to train the generator and the discriminator to enable the discriminator to correctly perform the discrimination. The generator thus trained is used as means for obtaining the image code area from the input image.

### SUMMARY

Suppose a case where machine-learning-based artificial intelligence (AI) such as a neural network is used to recognize the types of objects in an image. A general conceivable approach is training AI by providing the AI with the image of each object as input data and a code representing the type of the object as training data.

In the method for training AI by providing a code representing an object type as training data, there is a possibility that the training does not converge depending on the type. If the training for the type does not converge, it is not possible for the AI to determine the type.

Aspects of non-limiting embodiments of the present disclosure relate to providing an apparatus enabled to determine a larger number of image types than the number of types determined by the method for training AI by providing a code representing a type as training data.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: in a color assignment state where mutually different colors are each assigned to a corresponding one of types of images, input target images to artificial intelligence trained by machine learning and acquire post-conversion images each resulting from conversion of a corresponding one of the target images, the conversion being performed by the artificial intelligence trained to convert an input image to a pattern image of a solid color serving as the color assigned to the type of the input image or to a pattern image of multiple colors; and in the color assignment state, execute a determination process for determining a type of each target image on a basis of closeness between a color of the corresponding post-conversion image and each of the colors assigned to the types of images.

### BRIEF DESCRIPTION OF THE DRAWINGS

An exemplary embodiment of the present disclosure will be described in detail based on the following figures, wherein:

FIG. 1 is a diagram explaining the functional configuration of an information processing apparatus of this exemplary embodiment;

FIG. 2 is a diagram illustrating the configuration of an inference unit;

FIG. 3 is a diagram illustrating input images and correct images used for learning and output images output by the trained inference unit in response to the input images;

FIG. 4 is a diagram explaining a process executed by a unification unit;

FIGS. 5A and 5B are each a view illustrating a display example in Modification 1 and respectively illustrate the use of a color distribution image and a target image;

FIG. 6 is a diagram illustrating how blocks are mapped in Modification 3; and

FIG. 7 is a block diagram schematically illustrating the configuration of a computer serving as the base of the information processing apparatus.

### DETAILED DESCRIPTION

### Overall Configuration

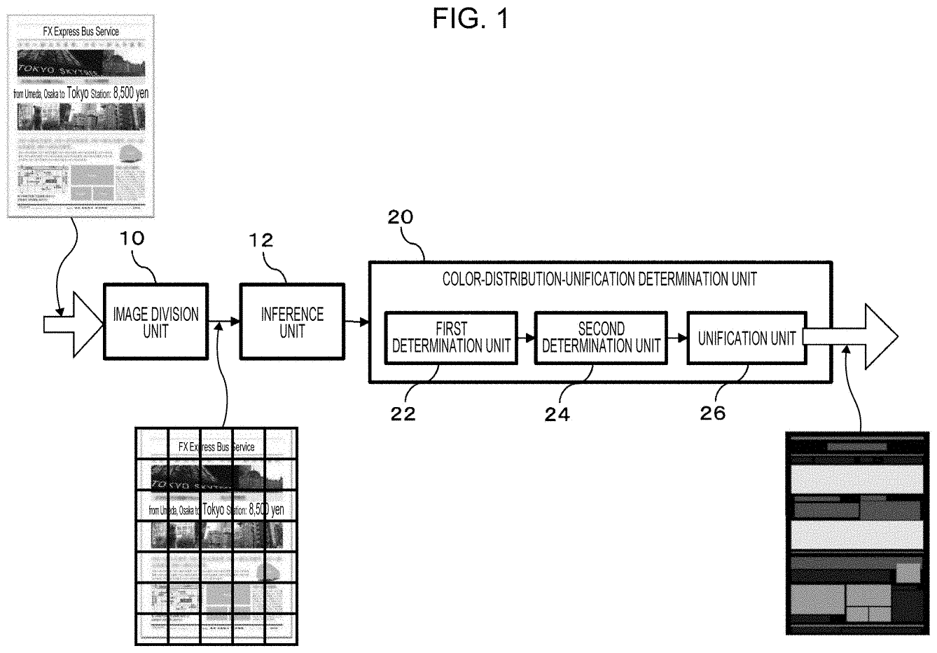

The functional configuration of an information processing apparatus of this exemplary embodiment will be described with reference to FIG. 1. The information processing apparatus of this exemplary embodiment is an apparatus for recognizing an object included in an input image such as a document and the type of the object, that is, the classification attribute thereof. For example, in a document image, examples of the type of the object included in the document image include Photo, Map, and Text. The object type intended to be recognized from the image and the number of types may be optionally decided according to the intended use.

The information processing apparatus illustrated in FIG. 1 includes an image division unit 10, an inference unit 12, and a color-distribution-unification determination unit 20. The information processing apparatus is configured as a computer including a processor, a memory, and other components and processes an input image in such a manner that the processor runs an appropriate one of programs stored in the memory. The information processing apparatus may be configured as one computer or computers connected using a communication network.

The information processing apparatus receives an image to be processed (hereinafter, referred to as a target image), and the image division unit 10 divides the target image into blocks. Note that the image of each block resulting from the division by the image division unit 10 is also appropriately referred to as a target image because the image is to be processed. The image input before the division into the blocks is also referred to as a first image.

Each block is a square or rectangular area of a predetermined size. The size of the block, that is, the number of horizontally and vertically arranged pixels, is not particularly limited but may be, for example, 256 pixels×256 pixels. The block resulting from the division by the image division unit 10 is input to the inference unit 12.

The inference unit 12 infers the object type of an object as an image in each input block.

The inference by the inference unit 12 is a process for converting the image in the block to an image having a pattern of a color applicable to the type of an object in the image (hereinafter, referred to as a color pattern image). In other words, the inference unit 12 outputs a color pattern image as the result of the inference for the input block. Since the inference unit 12 converts the target image resulting from the division into the blocks to the color pattern image and outputs the color pattern image as a conversion result, the color pattern image is also referred to as a post-conversion image. In a typical example, the color pattern image is a solid color image of a color applicable to the object type, that is, an image entirely filled with the color.

However, outputting the solid color image by the inference unit 12 as the color pattern image as the inference result is merely an example, and outputting an image representing a multicolor pattern is also conceivable. Hereinafter, a typical case where the inference unit 12 outputs a solid color image as the inference result will first be described taken as an example, and then a case where the inference unit 12 outputs an image having a multicolor pattern will be described.

In a case where a solid color image is used as the color pattern image, colors mutually discriminatable are assigned to the respective object types for ease of type-based color separation. For example, each color to be assigned to the corresponding type is set to have an appropriately large hue angle difference from the adjacent colors in the hue circle, for example, a difference larger than or equal to a predetermined threshold. For example, colors making sufficient hue angles are assigned to the respective object types in such a manner that blue is assigned to Photo; green, Map; red, Black Text (that is, black text with a white background); and magenta, Color Text (that is, a text area colored for at least one of text and the background). To assign the colors, for example, the pitch of the hue angles is decided according to the number of types to be determined, and type colors the pitch away from each other in the hue circle may be selected. The pitch may be, for example, a number obtained by dividing 360 degrees corresponding to the circumference of the hue circle by the number of types.

A color to be assigned to a type similar to the type of the color may be located closer in the hue circle than to a color to be assigned to a less similar type.

Each color pattern image output by the inference unit 12 as the inference result typically has the same size and shape as those of the block input to the inference unit 12. However, the color pattern image (for example, a solid color image) in the block may be made smaller than the block. It is conceivable that, for example, adjacent blocks are set to partially overlap with each other, the color pattern image obtained in each block is set to have a dimension corresponding to the dimension of a non-overlapping portion (described later), and thereby the inference accuracy of a boundary portion between different objects is improved.

Hereinafter, a typical case where the inference unit 12 outputs, as the inference result, a solid color image of the same shape and size as those of an input block will first be described.

The inference unit 12 is configured as AI using machine learning. The AI used as the inference unit 12 may be AI using a neural network or any other method. In the following description, for example, a GAN as a sort of a neural network is used as the inference unit 12. The example of the inference unit 12 using the GAN will be described in detail later.

The inference unit 12 acquires a color pattern image (that is, a post-conversion image also including a solid color image) as the inference result for each block in the target image, assigns the color pattern image to the corresponding block in the target image, and acquires an output image (that is, a second image) corresponding to the target image yet to be divided into the blocks.

The color-distribution-unification determination unit 20 determines the color distribution in the target image, that is, the distribution of object types on the basis of the output image (second image) that is the inference result output by the inference unit 12. The output image is generated in such a manner that each color pattern image output on a per-block basis is disposed in a location corresponding to that in the first image. The color-distribution-unification determination unit 20, for example, generates and outputs a color distribution image (third image) representing the object types in the target image by using color distribution. A detailed process by the color-distribution-unification determination unit 20 and an example of the color distribution image will be described later. The color-distribution-unification determination unit 20 may determine the types in units of a block or in units other than a block. The unit of processing by the color-distribution-unification determination unit 20 is thus referred to as a window. The window may be the same as or different from the block.

### Inference Unit

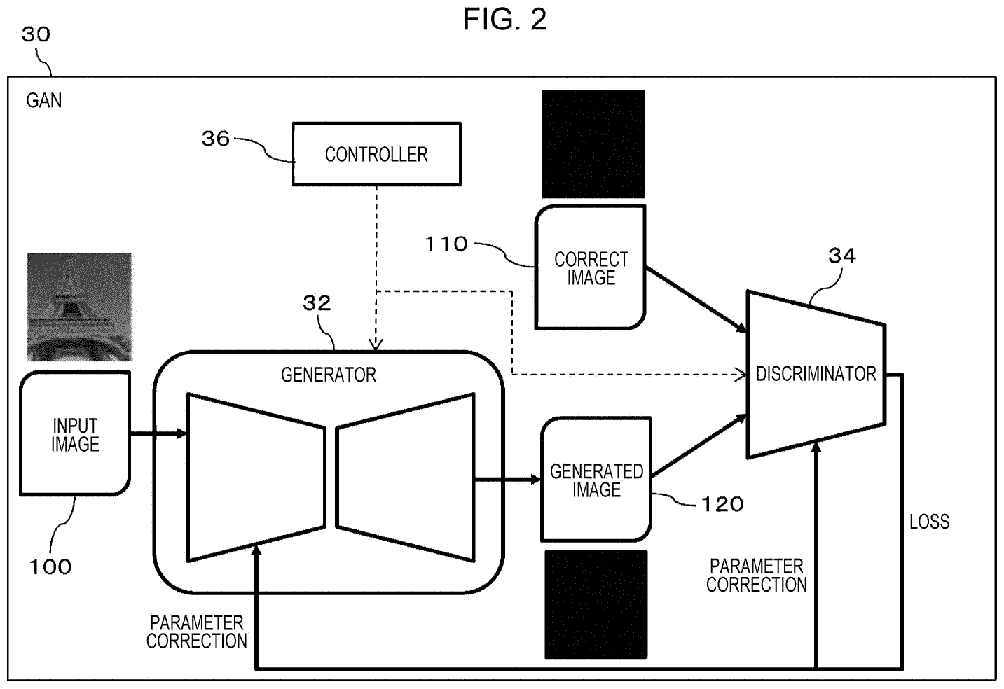

The inference unit 12 will be described in more detail with reference to FIG. 2. FIG. 2 illustrates an example of configuring the inference unit 12 by using the GAN.

A GAN 30 illustrated in FIG. 2 includes a generator 32 and a discriminator 34. The generator 32 after the sufficient training of the GAN 30 is used as the inference unit 12.

A large number of pairs of an input image 100 and a correct image 110 are prepared as learning data for the GAN 30. Each of the input images 100 is an image in the corresponding resultant block of a predetermined size generated according to the object type Photo, Text (Character), Map, Graphic, or the like. The image in the resultant block is obtained, for example, by cutting out a portion that is of the predetermined size and that represents an object of a certain type. The size of each input image 100 is the same as the size of each block generated from the division by the image division unit 10. Each of the correct images 110 is an image of a solid color assigned to the object type of the input image 100 in this example. The shape and size of the correct image 110 are the same as the shape and size of the input image 100 in this example.

The generator 32 is a neural network that generates generated images 120 from the respective input images 100. Each generated image 120 is an image obtained by inferring a corresponding one of the correct images 110 paired with one of the input images 100. In this example, the shape and size of the generated image 120 are the same as those of the input image 100. The generator 32 processes a large number of input images 100 and thereby is trained to be able to infer a correct image more correctly.

The discriminator 34 is a neural network that discriminates whether an input image is the correct image 110 for the input image 100 or the generated image 120 generated by the generator 32 from the input image 100. A controller 36 inputs the correct image 110 or the generated image 120 to the discriminator 34. In response to this, the discriminator 34 discriminates whether the input image is the correct image 110 (that is, a correct image) or the generated image 120 (that is, a false image) and outputs a signal representing the discrimination result.

The controller 36 compares the discrimination result of whether the image input to the discriminator 34 is a correct image or a false image with the output signal from the discriminator 34 and gives feedback to a weighting parameter for unification of nodes in the neural network of each of the generator 32 and the discriminator 34 by using a loss signal based on the comparison result. The generator 32 and the discriminator 34 are thereby trained.

The generator 32 and the discriminator 34 constituting the GAN 30 go on with the learning in friendly rivalry with each other in such a manner that the generator 32 makes efforts to generate a false image (that is, the generated image 120) as close to training data (that is, the correct image 110) as possible and that the discriminator 34 makes efforts to correctly discriminate the false image.

A method, for example, similar to the algorithm “pix2pix” (see the thesis “Image-to-Image Translation with Conditional Adversarial Networks”, Phillip Isola, et al., Berkeley AI Research (BAIR) Laboratory, UC Berkeley) may be used for the GAN 30. In this case, not only the loss signal from the discriminator 34 but also a difference between the correct image 110 and the generated image 120 is given as feedback for the learning by the generator 32.

In another example, CycleGAN may be used as the GAN 30. With the use of CycleGAN, the learning may be performed even in the case where correct images are prepared for not all of the input images.

Whether the GAN 30 finishes the learning may be determined in the same manner as in a GAN in the related art.

In response to the input image 100, the generator 32 of the GAN 30 having finished the learning outputs an image of approximately a solid color assigned to the type of the object included in the input image 100. The trained generator 32 is used as the inference unit 12 of the information processing apparatus in FIG. 1.

The trained generator 32, that is, the inference unit 12 outputs an image as an inference result for an input image, that is, a block. The image output by the inference unit 12 (hereinafter, referred to as an output image) does not necessarily result in a solid color image such as a correct image. In addition, the output image from the inference unit 12 has, on occasions, hue different to some extent from the color assigned to an object represented in the input block.

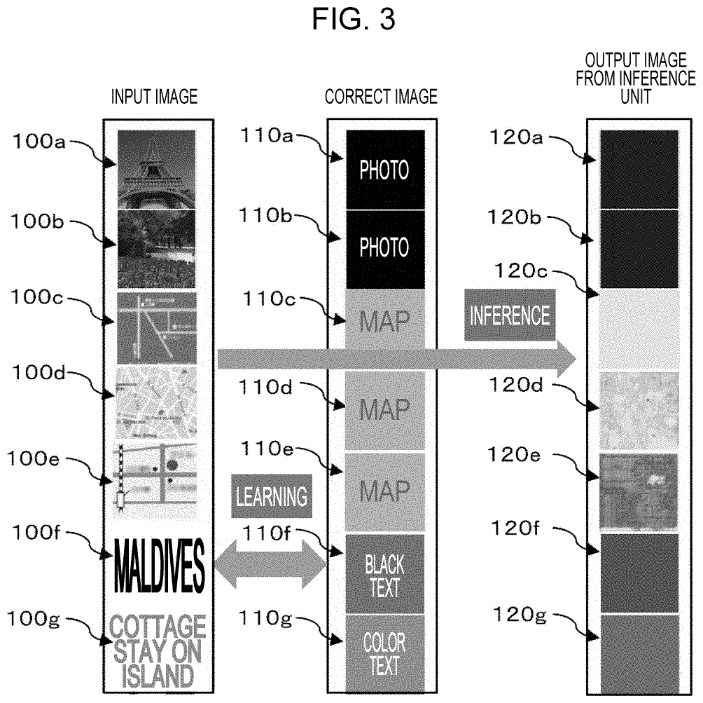

FIG. 3 illustrates input images and correct images each of which is used for the learning. FIG. 3 also illustrates output images output for the input images by the trained inference unit 12. In the example in FIG. 3, the GAN 30 learns four object types of Photo, Map, Black Text, and Color Text. In FIG. 3, the type of each of input images 100a and 100b is Photo; the type of each of input images 100c, 100d, and 100e, Map; the type of an input image 100f, Black Text; and the type of an input image 100g, Color Text.

Colors assigned to the respective types Photo, Map, Black Text, and Color Text are respectively blue, green, red, and magenta. Correct images 110a and 110b for Photo are solid color images of blue. Correct images 110c, 110d, and 110e for Map are solid color images of green; a correct image 110f for Black Text, a solid color image of red; and a correct image 110g for Color Text, a solid color image of magenta. Since FIG. 3 is drawn in black and white, these colors are represented by using densities. FIG. 3 has text representing object types such as Photo in the correct image 110a and other correct images. The text is provided for explanation, and actual correct images do not include such text.

The GAN 30 including the generator 32 performs the learning by using a large number of pairs of the input images 100a to 100g and the correct images 110a to 110g. Output images 120a to 120g are images output by the trained generator 32, that is, the inference unit 12 in a case where the input images 100a to 100g are input.

In the example in FIG. 3, for example, the output images 120a and 120b for the input images 100a and 100b representing a photo are close to the solid color images of blue as the corresponding correct images 110a and 110b. However, the output images 120a and 120b do not necessarily result in completely solid color images in which the color of all of the pixels is blue. There may be a case where a color other than blue representing a different object type is mixed up being influenced by the original input images 100a and 100b.

In contrast, although it is not easy to recognize from the monochrome drawing, the output images 120c, 120d, and 120e for the input images 100c, 100d, and 100e representing a map represent a reddish diagram with a yellow background. It is conceivable that the reddish diagram derives from text on the map or a graphic such as a road. As described above, the output images 120c, 120d, and 120e representing a map are considerably different from the corresponding correct images 110c, 110d, and 110e, that is, solid color images of green but have a characteristic common to Map that red is slightly mixed up with yellow.

The output image 120f for the input image 100f representing black text is close to the correct image 110f that is the solid color image of red. The output image 120g for the input image 100g representing color text is close to the correct image 110g that is the solid color image of magenta.

In the example in FIG. 3, as described above, the learning for the object types other than Map has been successfully performed. As for Map, the result of the inference by the inference unit 12 is different from the solid color image of green as the correct image but has the common Map characteristic that a reddish pattern is mixed up with the yellow background. Hence, for example, it is conceivable that if the result of the inference by the inference unit 12 for the input image 100 is yellow or slightly reddish yellow, the type of the input image 100 is determined as Map.

### Color-Distribution-Unification Determination Unit

Referring back to FIG. 1 in the explanation, the color-distribution-unification determination unit 20 determines the object type of each block on the basis of the output image from the inference unit 12 for the block and generates a color distribution image (third image) representing the types of the blocks by using colors. In this example, the color-distribution-unification determination unit 20 includes a first determination unit 22, a second determination unit 24, and a unification unit 26.

The first determination unit 22 receives each output image for the corresponding block from the inference unit 12 and determines the model color of the output image. The model color of the output image is a color representative of the color of the entire output image. An average color may be used as the model color of the output image. The average color is obtained by averaging the colors of the respective pixels of the output image. For example, the average color of the output image 120c representing a map in the example in FIG. 3 is slightly reddish yellow.

The second determination unit 24 determines the object type of the block on the basis of the color of the result of the determination for the block by the first determination unit 22 (that is, a model color). In the determination process, from among the colors assigned to the respective types of the objects (hereinafter, referred to as type colors), a type color close to the model color of the block is identified, and a type represented by the type color is determined as the type of the block. The type color may be the same as the color of the corresponding correct image. The second determination unit 24 may determine the type color for each block or, for example, for each window of a size different from the size of the block (for example, smaller than the block). However, in this exemplary embodiment, the window has the same size as the size of the block, and the determination is performed for each block in the following description.

Note that the term “type color close to the model color” denotes a type color a specific distance away from the model color in the hue circle. The distance is shorter than or equal to a predetermined threshold distance. If type colors are away from each other making an appropriate hue angle or larger in the hue circle, and if the threshold is set appropriately, the type color away from the model color by a distance shorter than or equal to the threshold is limited to one type color. The distance from the model color to the type color is a distance from the coordinates of the model color to the coordinates of the type color in a predetermined color space such as a RGB color space.

In another example, the type color close to the model color may be determined in the following manner. Specifically, a hue angle and chroma are obtained for each of the model color and a type color. If differences in hue angle and chroma between the model color and the type color are smaller than or equal to respective predetermined thresholds, the type color is determined as the type color close to the model color. Also in this case, if type colors are away from each other making an appropriate hue angle or larger in the hue circle, and if the threshold is set appropriately, the type color satisfying the condition is limited to one type color.

The second determination unit 24 outputs values indicating the respective types of the blocks determined as described above. Output data output from the second determination unit 24 may be any data usable to identify the type of each block to which pixels in the target image belong.

For example, the output data may have a value obtained for each pixel and indicating the type of the block to which the pixel belongs. In another example, the output data may have combination of a value obtained for each block and indicating the type of the block with location information regarding the block in the target image. Since the value indicating the type of the block is mapped to the color assigned to the type, knowing the value indicating the type of the block enables the block to be displayed in the color assigned to the type.

In still another example, the second determination unit 24 may output, as the output data, an image in each block filled with the color of the type of the block. Also in this example, the type of the block is identified from the color of the block or the color of the pixels in the block.

A described above, the output data from the second determination unit 24 is regarded as a soft of image data indicating the type of the block to which the pixels belong.

The unification unit 26 generates a color distribution image indicating the types of the objects in the target image from the values of the results of the determination for the blocks output by the second determination unit 24.

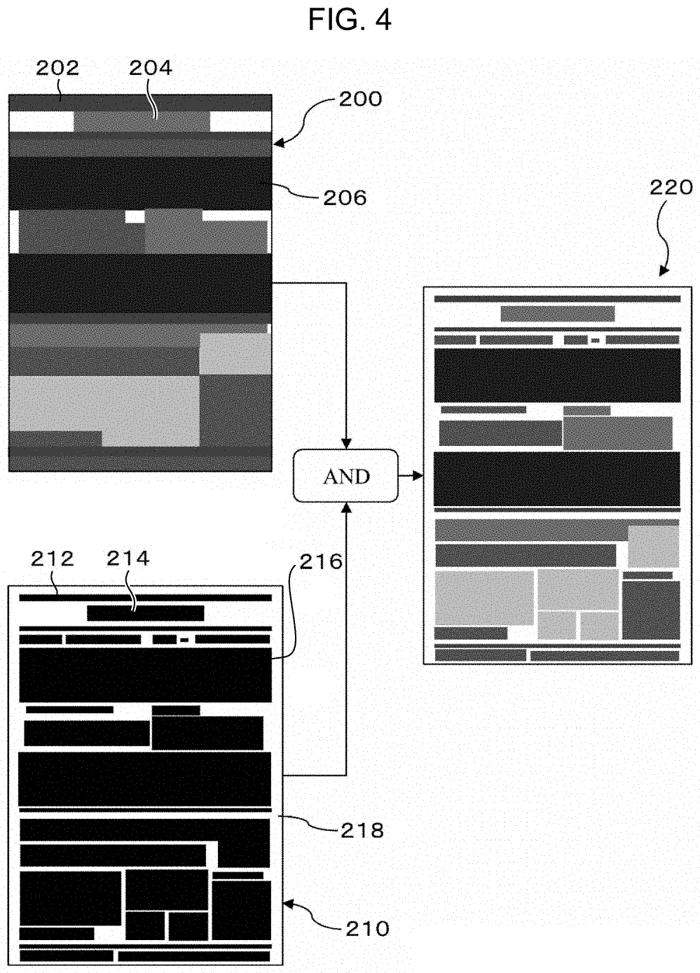

As illustrated in FIG. 4, the output data from the second determination unit 24 is an image 200 indicating the types of blocks on a per-block basis. Generally, boundaries between blocks do not coincide with boundaries between individual objects, and thus the color distributions of the image 200, that is, the type distributions are slightly displaced from the individual objects in the target image. The unification unit 26 thus applies a mask 210 prepared in advance to the image 200. The mask 210 is image data used to extract one or more image portions in the target image from the background portion. In the example illustrated in FIG. 4, the mask 210 is an image based on binary values indicating black and white (for example, values of 0 and 1 respectively indicating white and black). Pixels belonging to image portions in the target image, that is, pixels belonging to objects 212, 214, and 216 are black, and pixels in the background portion are white (that is, colorless). The mask 210 may be generated from the target image by using a technique in the related art.

The unification unit 26 performs an AND operation on the image 200 and the mask 210 for each pixel, and thereby values for the pixels in the objects in the image 200 are used for the pixels. For the pixels belonging to the background portion, a specific value indicating a background is used. Note that the specific value is a predetermined value (for example, the value of 0 indicating that the pixels are colorless) different from any value indicating an object type. An image resulting from the AND operation is a color distribution image 220 output by the color-distribution-unification determination unit 20.

The information processing apparatus may display the thus generated color distribution image 220 on the screen, for example, to present the distribution of the object types in the target image to a user. In the displaying, an image is drawn on the basis of the values of the types of the pixels by using colors assigned to the respective types.

The information processing apparatus may have a function of referring to the color distribution image 220 and thereby performing information processing appropriate for the object type of an object in the target image.

### Block Including Objects of Different Types

A block includes objects of different types on occasions. Such inclusion may occur in a case where a block is located in the boundary portion between the objects.

In contrast, in the example described above, the inference unit 12 learns input images each including an object of one type. If the input block includes one or more objects of only one type, an image resulting from the inference by the inference unit 12 is basically close to a solid color image of a color assigned to the type. However, an input block includes objects of different types, the inference unit 12 has an inference result considerably different from such a solid color image. Using such an output image for the determination by the first determination unit 22 and the second determination unit 24 may cause a wrong determination.

To prevent the wrong determination as described above, there is a method as below.

In the method, before obtaining each model color of the corresponding image (image in the block) resulting from the inference for the block by the inference unit 12, the first determination unit 22 generates a histogram regarding colors in the image. In other words, the histogram is a graph with the horizontal axis representing a color value and the vertical axis representing the number of pixels having respective color values, that is, a frequency. A pixel value itself (for example, in the RGB color system, a set of R, G, and B values) may be used as the color value represented by the horizontal axis of the histogram. In another example, a hue angle obtained from the pixel value may be used as the color value.

The first determination unit 22 determines whether the block includes objects of more than one type on the basis of the histogram. If color values each have a frequency proportion (that is, the proportion of the frequency of a color value to the total frequency) higher than or equal to a predetermined value in the determination, the block is determined to include objects of more than one type. Alternatively, if the histogram has more than one peak, the block may be determined to include objects of more than one type.

If the first determination unit 22 does not determine that the block includes objects of more than one type, the first determination unit 22 executes the above-described process for obtaining the model color of the image resulting from the corresponding inference. The second determination unit 24 then determines the type of the block on the basis of the model color.

In contrast, if the first determination unit 22 determines that the block includes objects of more than one type, for example, the first determination unit 22 outputs a color-coded image for the block. The image is color-coded in typical colors indicated by the histogram. The typical colors indicated by the histogram are, for example, colors accounting for a frequency proportion higher than or equal to the predetermined value or colors represented by the respective peaks in the histogram. The pattern for the color-coding may be selected from predetermined one or more patterns. As described above, the color-coded image may be input in an example (described in detail later) in which a window used in the determination by the second determination unit 24 is made smaller than the block.

### Modifications

### Modification 1

In the example above, the second determination unit 24 determines the type color close to the model color of the block. However, as in the example of Map described above, the tint of the image resulting from the inference by the inference unit 12 (that is, reddish yellow in the case of Map) is different to some extent from the type color assigned to the type (that is, green to Map) on occasions. In such a case, there is a possibility that a type color at a distance (for example, a color difference) from the model color of the block shorter than or equal to the threshold is not found in the determination by the second determination unit 24.

To address this, the following method may be used.

In Modification 1, if a type color at a distance from the model color of the block shorter than or equal to the threshold is not found, the user inputs a type, and thereby the type of the block (an indeterminable portion) is decided.

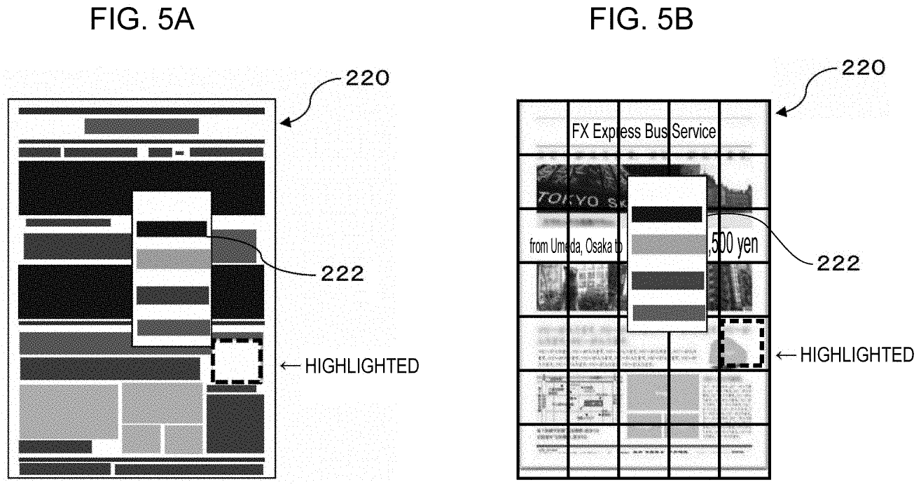

FIGS. 5A and 5B are each a view illustrating a display example in Modification 1 and respectively illustrate the use of a color distribution image and a target image.

In the example in FIG. 5A, a fourth image is displayed. The fourth image has a highlighted block for which the type color is not decided in the color distribution image 220 output by the color-distribution-unification determination unit 20. In the example in FIG. 5A, the block is highlighted by using a thick broken line on the contour of the block to represent a color (white in this example) that is not a type color. Note that the block may be highlighted in various manners such as by blinking or by displaying text. In response to the user clicking on the highlighted block, a pop-up selection screen 222 for a type color as illustrated in FIG. 5A appears. In response to the user deciding and clicking on a type (a type color in this example), the type color is selected for the target block, and the color distribution image 220 is complete.

In the example in FIG. 5B, the fourth image is displayed by using the target image. The fourth image has a highlighted block for which the type color is not decided. The target image is used for prompting the user to verify the content of the block for which the type color is not decided and to select the type of the block.

As described above, the type of the block for which the type is not determined may be decided by prompting the user to perform the determination. The color distribution image 220 and the target image each having the highlighted portion for which the type color is not decided may be displayed parallel to each other. The user selects the type of the highlighted portions in the two images while looking at the portions.

The information regarding the type selected by the user in the above manner may also be used to discriminate an object in a new target image input to the information processing apparatus in the future. In other words, in the information processing apparatus, the model color of a block for which the type is not automatically distinguished is set as a new type color representing the type selected for the block by the user by the method in this modification. Specifically, the type color for the type of the block first used for the learning is discarded, and the model color of the block is set as the type color for the type. The type color for the type difficult to automatically determine is thereby replaced with a color close to a color actually output for the object of the type by the inference unit 12. This facilitates the automatic determination of the type of the object of the type included in the target image to be input in the future. In addition, the information regarding the type selected by the user in the above manner may be used to train the inference unit 12 again or additionally.

### Modification 2

In the examples above, the inference unit 12 is trained such that green represents the type Map. However, it is known that the trained inference unit 12 outputs not a green image but a slightly reddish yellow image in response to inputting a map. In this case, if it is determined that the model color of the yellow image output for the block of the type Map by the inference unit 12 is close to green, this does not cause trouble. However, there is a possibility that the determination has a different result. Hence, if the result of the determination by the first determination unit 22 is yellow, the second determination unit 24 may determine the type as Map and output green for the block.

For example, samples of various types are input to the trained inference unit 12. The colors output for the respective samples by the inference unit 12 are categorized, for example, averages are obtained. The color of inference results of the samples is thereby decided on a per-type basis. In other words, in a case where an image of a certain type is input, a color to be output by the inference unit 12 may be known. The second determination unit 24 compares the model color provided by the first determination unit 22 with the color of the inference result obtained on a per-color basis as described above, not with the type color. For example, although the type color for the type Map is green, the color of the inference result is yellow. Accordingly, if the model color of the result of the determination by the first determination unit 22 is yellow, the type may be determined as Map, and green is output as the result of the determination by the second determination unit 24.

### Modification 3

A large block is likely to include objects of different types that are mixed up in the block. Making resolution higher reduces a possibility of the mixing and improves determination accuracy.

In Modification 3, the result of the inference by the inference unit 12 is allocated not as the result for the whole target block in the mapping but as the result for a part of the block (for example, a central area with half dimensions).

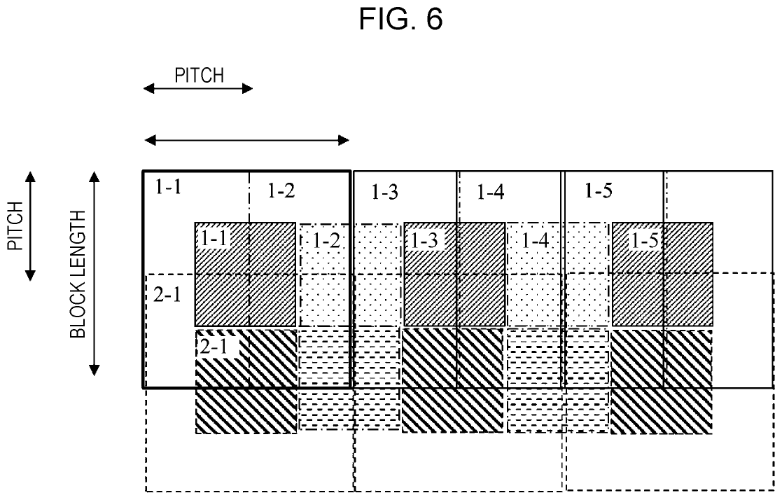

FIG. 6 illustrates how blocks are mapped in Modification 3. First, the inference result for a block 1-1 in the upper left corner is allocated to a central area having a ½ length and width and a ¼ area of the block. The moving pitch of a block as an inference target is set as ½ of the width of each block. The inference target block is moved in the horizontal direction (rightwards in the example in FIG. 6) in the order of 1-1, 1-2, 1-3, and . . . in a state where a half of the block overlaps with the previous block. The recognized areas are consecutively arranged without a gap. For the vertical direction (downward direction in the example in FIG. 6), the pitch is likewise set as ½ of the length of the block. Inference results for all of the input image areas may thereby be obtained except a peripheral frame area having a half block width or height. For the peripheral frame area, inference results may be obtained by a publicly known method, for example, in which an input image corresponding to one block in a right or left direction is copied.

As described above, limiting the area for allocating the inference result to the central portion enables improved inference accuracy.

For example, if one block has 256 pixels×256 pixels, the block is (i) a 32 mm square in the case of 200 dpi or (ii) a 16 mm square in the case of 400 dpi, and thus a relatively large block is processed. In such a case, the accuracy for an area having different image objects located close to each other may be improved. Although the block is of the size of 256 pixels×256 pixels in this example, an inference result for the central area having 128 pixels×128 pixels is used, and the target block is moved in units of 128 pixels along the X and Y axes with blocks overlapping with each other.

Note that an amount of overlapping may be set freely, but about 30% to 70% may be appropriate in consideration of the effects thereof.

### Modification 4

In the exemplary embodiment above, the same block undergoes all of the inference by the inference unit 12 and the determination by the first determination unit 22 and the second determination unit 24 on a per-block basis. In contrast in Modification 4, a window independent from the block undergoes the determination by the second determination unit 24 on a per-window basis. The size of the window is not particularly limited. For example, making a window smaller than a block may aim for higher determination accuracy.

The second determination unit 24 obtains a type color close to the color of the pixels in the window (for example, an average color). The determination process itself using the window may be performed in the completely same manner as for the block on the following condition. Specifically, an image obtained by laying out blocks of respective model colors is divided into windows, and the windows undergo the determination and are allocated in the respective corresponding locations for the division.

Further, from the same point of view as for Modification 3 above, the determination result for the window may be allocated to a partial area of the window (for example, a central area with half dimensions) in the mapping. In this case, the target window is moved, for example, by a half width to perform the determination in location of the window, and thereby higher resolution is achieved like Modification 3.

### Modification 5

It is also conceivable that a block (or a window) includes images of more than one type as described above (such a block is referred to as a mixed-type block). In this case, the correct image is not a solid color image but a color-coded image of more than one color (multicolor-coded image). To address this, the inference unit 12 has been trained for the mixed-type block by using multicolor-coded images as correct images. For example, correct images each having one or more different colors each allocated to a corresponding portion close to any one of the four sides are also prepared for the learning. If the same target image as the correct image is input to the inference unit 12 that has finished the learning, the same multicolor-coded pattern image as the correct image is output. Actually, the multicolor-coded pattern image is output. If a multicolor-coded image is also used for each of the model color and the type color, the first determination unit 22 and the second determination unit 24 may obtain the same determination result as the correct image. Blocks are rearranged for the obtained images, and the unification unit 26 performs the unification process. The case where one block includes more than one object may thereby be addressed.

### Others

In the exemplary embodiment above, the recognition of an object (type recognition) in the document, such as a natural image, a text image, or an image having both an image and text, has been described. However, the exemplary embodiment is applicable to the general distinction of the type of an object in the image. For example, the exemplary embodiment is applicable to the discrimination of an object in the image captured by augmented reality (AR) glasses or an onboard camera, and may also discriminate a person partially captured in the image.

Suppose a case where the type of a target image is not distinguished as one type, that is, the color of a boundary between different objects has not been learned. In this case, an inference result image in a window including the boundary between the objects of different types tends to have the following colors. Specifically, the color of a portion closer, than the other portions, to the peripheral portion of the window is close to the color of the type of a window adjacent to the peripheral portion, and the color of the central portion is close to a color obtained by mixing all of the colors together (gray scale).

In such a case, the boundary portion is further divided into smaller areas, and the type of each area is determined. The type of the remaining central portion may be determined independently. This enables each type color of the corresponding area to be determined and thus enables higher resolution. In other words, an indeterminable block (window) is further divided into small areas to perform the determination, and higher resolution may thereby be achieved.

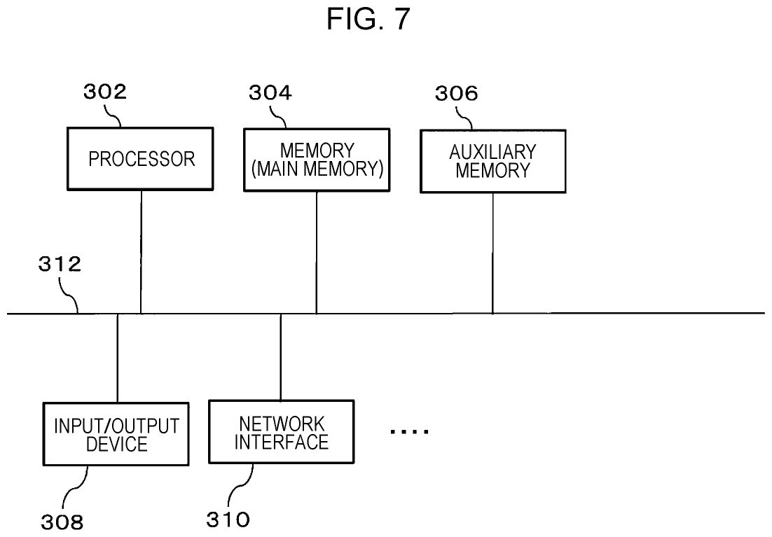

In addition, object types may be determined on the basis of higher resolution in the following manner. The resolution of target images input to the information processing apparatus are made higher by using a method for achieving high resolution such as interpolation or superresolution, and thereafter the method in the exemplary embodiment above is applied to the target images. The information processing apparatus in the exemplary embodiment above is configured as, for example, a general-purpose computer. As illustrated in FIG. 7, the computer serving as the base of the information processing apparatus has a circuit configuration in which components as below are connected via a data transmission path such as a bus 312: a controller that performs control of a processor 302, a memory (main memory) 304 such as a random-access memory (RAM), an auxiliary memory 306 as a non-volatile memory such as a flash memory, a solid state drive (SSD), or a hard disk drive (HDD); an interface with various input/output devices 308; a network interface 310 that performs control for connection to a network such as a local area network; and other components. A program describing the content of processes in the exemplary embodiment above is installed on the computer via a network and stored in the auxiliary memory 306. The processor 302 runs the program stored in the auxiliary memory 306 by using the memory 304, and thereby the information processing apparatus of this exemplary embodiment is configured.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
in a color assignment state where mutually different colors are each assigned to a corresponding one of types of images,
input target images to artificial intelligence trained by machine learning and acquire post-conversion images each resulting from conversion of a corresponding one of the target images, the conversion being performed by the artificial intelligence trained to convert an input image to a pattern image of a solid color serving as the color assigned to the type of the input image or to a pattern image of a plurality of colors; and
in the color assignment state, execute a determination process for determining a type of each target image on a basis of closeness between a color of the corresponding post-conversion image and each of the colors assigned to the types of images.

2. The information processing apparatus according to claim 1,
wherein the processor is configured to:
execute the determination process on a basis of the color of the post-conversion image and a color distribution image color-coded with the colors each assigned to the corresponding type.

3. The information processing apparatus according to claim 1,
wherein the processor is configured to:
input, as the target image, a portion of each of blocks set in an input first image to the artificial intelligence and acquire a post-conversion image corresponding to the block from the artificial intelligence;
generate a second image by disposing the acquired post-conversion image in the second image in a location corresponding to a location of the block in the first image;
execute the determination process for each of windows set in the second image, the determination process being executed by using, as the target image, each of portions of the respective windows in the second image; and
perform control to generate and display a third image representing distribution of the types in the first image, the third image being generated on a basis of determination results obtained for the respective windows in the determination process.

4. The information processing apparatus according to claim 2,
wherein the processor is configured to:
input, as the target image, a portion of each of blocks set in an input first image to the artificial intelligence and acquire a post-conversion image corresponding to the block from the artificial intelligence;
generate a second image by disposing the acquired post-conversion image in the second image in a location corresponding to a location of the block in the first image;
execute the determination process for each of windows set in the second image, the determination process being executed by using, as the target image, each of portions of the respective windows in the second image; and
perform control to generate and display a third image representing distribution of the types in the first image, the third image being generated on a basis of determination results obtained for the respective windows in the determination process.

5. The information processing apparatus according to claim 3,
wherein the blocks are set to overlap with each other in the first image, and the post-conversion image is acquired for each block from the artificial intelligence, the post-conversion image being smaller than the block, and
wherein the second image has a unit in size as the post-conversion image smaller than the block.

6. The information processing apparatus according to claim 4,
wherein the blocks are set to overlap with each other in the first image, and the post-conversion image is acquired for each block from the artificial intelligence, the post-conversion image being smaller than the block, and
wherein the second image has a unit in size as the post-conversion image smaller than the block.

7. The information processing apparatus according to claim 3,
wherein in the determination process executed for each window, the windows are set to overlap with each other in the second image, and the determination results for the respective windows are obtained as types of respective areas in the windows, the areas each being smaller than a corresponding one of the windows, and
wherein the third image represents distribution of the determination results for the respective types of the areas.

8. The information processing apparatus according to claim 4,
wherein in the determination process executed for each window, the windows are set to overlap with each other in the second image, and the determination results for the respective windows are obtained as types of respective areas in the windows, the areas each being smaller than a corresponding one of the windows, and
wherein the third image represents distribution of the determination results for the respective types of the areas.

9. The information processing apparatus according to claim 5,
wherein in the determination process executed for each window, the windows are set to overlap with each other in the second image, and the determination results for the respective windows are obtained as types of respective areas in the windows, the areas each being smaller than a corresponding one of the windows, and
wherein the third image represents distribution of the determination results for the respective types of the areas.

10. The information processing apparatus according to claim 6,
wherein in the determination process executed for each window, the windows are set to overlap with each other in the second image, and the determination results for the respective windows are obtained as types of respective areas in the windows, the areas each being smaller than a corresponding one of the windows, and
wherein the third image represents distribution of the determination results for the respective types of the areas.

11. The information processing apparatus according to claim 3,
wherein control to generate and display a fourth image is performed, the fourth image representing an indeterminable portion being a portion in the first image, the portion corresponding to one of the windows for which the type is not determined in the determination process,
wherein after the fourth image is displayed, input for specifying the type for the indeterminable portion is received from a user, and
wherein in response to the input for specifying the type for the indeterminable portion, assignment of a color of a portion corresponding to the indeterminable portion in the second image to a color for the type is performed, and the assignment is used in the determination process for a second image generated from a different first image to be input later.

12. The information processing apparatus according to claim 4,
wherein control to generate and display a fourth image is performed, the fourth image representing an indeterminable portion being a portion in the first image, the portion corresponding to one of the windows for which the type is not determined in the determination process,
wherein after the fourth image is displayed, input for specifying the type for the indeterminable portion is received from a user, and
wherein in response to the input for specifying the type for the indeterminable portion, assignment of a color of a portion corresponding to the indeterminable portion in the second image to a color for the type is performed, and the assignment is used in the determination process for a second image generated from a different first image to be input later.

13. The information processing apparatus according to claim 5,
wherein control to generate and display a fourth image is performed, the fourth image representing an indeterminable portion being a portion in the first image, the portion corresponding to one of the windows for which the type is not determined in the determination process,
wherein after the fourth image is displayed, input for specifying the type for the indeterminable portion is received from a user, and
wherein in response to the input for specifying the type for the indeterminable portion, assignment of a color of a portion corresponding to the indeterminable portion in the second image to a color for the type is performed, and the assignment is used in the determination process for a second image generated from a different first image to be input later.

14. The information processing apparatus according to claim 6,
wherein control to generate and display a fourth image is performed, the fourth image representing an indeterminable portion being a portion in the first image, the portion corresponding to one of the windows for which the type is not determined in the determination process,
wherein after the fourth image is displayed, input for specifying the type for the indeterminable portion is received from a user, and
wherein in response to the input for specifying the type for the indeterminable portion, assignment of a color of a portion corresponding to the indeterminable portion in the second image to a color for the type is performed, and the assignment is used in the determination process for a second image generated from a different first image to be input later.

15. The information processing apparatus according to claim 7,
wherein control to generate and display a fourth image is performed, the fourth image representing an indeterminable portion being a portion in the first image, the portion corresponding to one of the windows for which the type is not determined in the determination process,
wherein after the fourth image is displayed, input for specifying the type for the indeterminable portion is received from a user, and
wherein in response to the input for specifying the type for the indeterminable portion, assignment of a color of a portion corresponding to the indeterminable portion in the second image to a color for the type is performed, and the assignment is used in the determination process for a second image generated from a different first image to be input later.

16. The information processing apparatus according to claim 8,
wherein control to generate and display a fourth image is performed, the fourth image representing an indeterminable portion being a portion in the first image, the portion corresponding to one of the windows for which the type is not determined in the determination process,
wherein after the fourth image is displayed, input for specifying the type for the indeterminable portion is received from a user, and
wherein in response to the input for specifying the type for the indeterminable portion, assignment of a color of a portion corresponding to the indeterminable portion in the second image to a color for the type is performed, and the assignment is used in the determination process for a second image generated from a different first image to be input later.

17. The information processing apparatus according to claim 9,
wherein control to generate and display a fourth image is performed, the fourth image representing an indeterminable portion being a portion in the first image, the portion corresponding to one of the windows for which the type is not determined in the determination process,
wherein after the fourth image is displayed, input for specifying the type for the indeterminable portion is received from a user, and
wherein in response to the input for specifying the type for the indeterminable portion, assignment of a color of a portion corresponding to the indeterminable portion in the second image to a color for the type is performed, and the assignment is used in the determination process for a second image generated from a different first image to be input later.

18. The information processing apparatus according to claim 1,
wherein an image input for the machine learning to the artificial intelligence includes a mixed-type image including images of a plurality of types, and an image having colors corresponding to the plurality of types is used as the pattern image corresponding to the mixed-type image in the machine learning.

19. The information processing apparatus according to claim 1,
wherein the mutually different colors assigned to the types of the images are colors located at a pitch of a hue angle in a hue circle, the pitch being decided on a basis of a count of the types.

20. A non-transitory computer readable medium storing a program causing a computer to execute a process comprising:
in a color assignment state where mutually different colors are each assigned to a corresponding one of types of images,
inputting target images to artificial intelligence trained by machine learning and acquiring post-conversion images each resulting from conversion of a corresponding one of the target images, the conversion being performed by the artificial intelligence trained to convert an input image to a pattern image of a solid color serving as the color assigned to the type of the input image or to a pattern image of a plurality of colors; and
in the color assignment state, executing a determination process for determining a type of each target image on a basis of closeness between a color of the corresponding post-conversion image and each of the colors assigned to the types of images.
